(19) United States
(12) Patent Application Publication
(10) Pub. No.: US 2006/0131034 A1
(43) Pub. Date: Jun. 22, 2006

(54) Fire extinguisher with a reservoir made from a plastic material

(76) Inventor: Michel Lahouati, Le Motte (FR)

Correspondence Address: YOUNG & THOMPSON, 745 SOUTH 23RD STREET, 2ND FLOOR, ARLINGTON, VA, 22202, US

(21) Appl. No.: 10/544,132

(22) PCT Filed: Feb. 3, 2004
(86) PCT No.: PCT/FR04/00236

§ 371 Date: Aug. 2, 2005

(30) Foreign Application Priority Data
Feb. 7, 2003 (FR) 03/01448

(51) Int. Cl. A62C 11/00

(52) U.S. Cl. 169/30; 169/74

(57) ABSTRACT

A fire extinguisher (61) with a reservoir made from a plastic material (60), for containing an extinguishing agent and a discharge device (65), fixed to a neck (64) of the reservoir, for controlling a discharge of the extinguishing agent. The discharge device has an outlet nozzle (70) and a plunge tube (69), arranged within the reservoir (60), such as to conduct the extinguishing agent from a base section (71) of the reservoir, opposite the neck, to the outlet nozzle, characterised in that a wall (62) of the reservoir has an internal rib (3) with a helical form, the coil axis of which (A) is essentially parallel to the plunge tube (69).

The present invention relates to a fire extinguisher of the type comprising a reservoir able to contain a pressurized extinguishing agent, and a discharge device fixed to a neck of said reservoir so as to discharge said extinguishing agent, said discharge device comprising an outlet nozzle, and a dip tube arranged in said reservoir in such a way as to be able to lead said extinguishing agent from a bottom part of said reservoir at the opposite end to said neck toward said outlet nozzle.

It is common practice to manufacture the reservoir of such an extinguisher in steel or in aluminum. In the case of aluminum reservoirs, the manufacturing process typically consists in steps of extruding, necking to form the neck and tapping the latter. In the case of steel reservoirs, the current manufacturing principles consist typically in steps of deep-drawing the bottom or body of the reservoir, machining the threaded ring or studs, manufacturing the shell ring, welding and assembling the various elements. These metal embodiments have disadvantages. Metals are hard and aggressive and do nothing to assist the user in holding the extinguisher in his or her hand if the user is inexperienced. Manufacturing rejects are often high after quality control. Manufacturing efficiency is poorly controlled. The residual level set by standards at 10% is often exceeded. The circular cylindrical shapes adopted by manufacturers by mutual assent are difficult to incorporate into an interior cabin, such as a motor cabin, a pleasure boat, a dwelling, which means that the extinguishers occupy excessive needless amounts of space or remain confined far from the points sensitive to and at risk from fire.

Document EP 283568 describes an extinguisher of the abovementioned type in which the reservoir is made of plastic by a process of stretching and blow-molding a preform. This method of manufacture makes it easier to obtain reservoirs of various shapes. However, the stretching operation entails gripping the preform in order to exert a tensile force thereon. Such gripping produces a region of welding between two opposed walls of the preform, which region constitutes a weak point in the container thus obtained. As a result, the working pressure of this known extinguisher is limited to 25 bar.

In this type of extinguisher, the extinguishing agent may be, for example, water with additives or a powder or a foam, etc. When the extinguisher is used, the extinguishing agent is discharged through the outlet nozzle of the discharge device under the thrust of a high pressure which is either contained permanently in the reservoir, in which case the discharge device comprises a valve, or released at the time of use by the puncturing of a gas cartridge within the reservoir, in which case the valve is not needed. One problem that arises in such a device is that a residual amount of extinguishing agent remains in the reservoir after the store of ejection pressure is exhausted and this leads to a loss of efficiency, additional cost and wastage. It is therefore desirable to reduce this residual amount of extinguishing agent as far as possible.

The object of the present invention is to remedy at least some of these disadvantages.

For that, the invention provides a fire extinguisher comprising a reservoir made of plastic able to contain a pressurized extinguishing agent, and a discharge device fixed to a neck of the reservoir so as to discharge the extinguishing agent, the discharge device comprising an outlet nozzle, and a dip tube arranged in the reservoir in such a way as to be able to lead the extinguishing agent from a bottom part of the reservoir at the opposite end to the neck toward the outlet nozzle, characterized in that a wall of said reservoir bears an internal rib of helical shape, the axis of winding of which is more or less parallel to said dip tube. Such a rib makes it possible to create or improve a vortex phenomenon at the time of discharge, that is to say to give the extinguishing agent a swirling movement. Such a movement is about the dip tube and ducts the flow of ejection agent toward the inlet of the dip tube while at the same time increasing the speed of the extinguishing agent as it is drawn up into the dip tube and discharged. The fluidity of the extinguishing agent, for example in the case of a powder, may also be improved by this movement. This results in a reduction in the residual amount of extinguishing agent and in a gain in efficiency.

Advantageously, said neck is formed of a double wall projecting toward the inside of said reservoir, which enhances the rigidity of the neck.

As a preference, said neck comprises an internal screw thread for fixing said discharge device by screwing. Such a fixing is better able to withstand the internal discharge pressure than a screw thread on the outside of the neck.

According to one particular embodiment of the invention, there is provided at least one external accessory molded as a projection on an exterior surface of said wall of the reservoir. Such an accessory may, for example, be a handgrip, a fixing lug, a stabilizing lug, a transport support or reinforcing piece. The extinguisher may thus be easier to store and to handle.

According to another particular embodiment of the invention, there is provided at least one external handgrip molded as a recess in said wall of the reservoir. The ergonomics of the extinguisher are thus improved, particularly in the case of a hand-held extinguisher.

The wall thickness of the reservoir is chosen to suit the material, the shape and the working pressure of the extinguisher. The helical rib has the advantage of improving the strength of the reservoir without there being any need to increase the thickness of the entire wall. This results in an improvement in safety, a saving of material and a saving of weight. For example, said wall of the reservoir has a thickness of between 3 and 5 mm. Thus, an internal working pressure in excess of 50 bar, for example, may be used.

The reservoir may be obtained in any shape that can be achieved by molding with bi-orientation. Advantageously, the reservoir has a polygonal cross section, which makes it easier for the extinguisher to be fitted into a small storage space, for example, in a vehicle.

According to one embodiment of the invention, the extinguishing agent is a powder or water with one or more additives.

As a preference, the reservoir can be obtained by a molding process with bi-orientation, advantageously without a preform, comprising steps of coating a moving mandrel bearing a helical groove and of blow-molding. One advantage of such a reservoir is that it has no welded seam, which means that its ability to withstand pressure is improved.

The invention will be better understood and other objects, details, features and advantages thereof will become more clearly apparent in the course of the following description of one particular embodiment of the invention, given solely by way of nonlimiting illustration with reference to the attached drawings.

### IN THESE DRAWINGS

FIG. 1 is a partial view in an axial section of a device according to a first embodiment suited to the manufacture of a reservoir of an extinguisher according to the invention, the accumulator being associated with a molding station,

FIG. 2 is an enlarged detailed view of a part of the accumulator of FIG. 1, the accumulator being associated with an injection station,

FIG. 3 is view similar to FIG. 1 depicting a step of extrusion by coating a mandrel,

FIG. 4 is view similar to FIG. 3 depicting a step of bi-orientation with pre-blowing,

FIG. 5 is view similar to FIG. 4 depicting the end of the blowing step,

FIG. 6 is an enlarged detailed view of a manufacturing device according to a second embodiment, the accumulator being associated with a molding station,

FIG. 7 is partial view depicting a variant embodiment of the mandrel,

FIG. 8 is a diagram depicting the timing sequence in the operation of the device of FIG. 1,

FIG. 9 depicts a portable extinguisher according to the invention, the reservoir of which can be obtained using the device of FIG. 6.

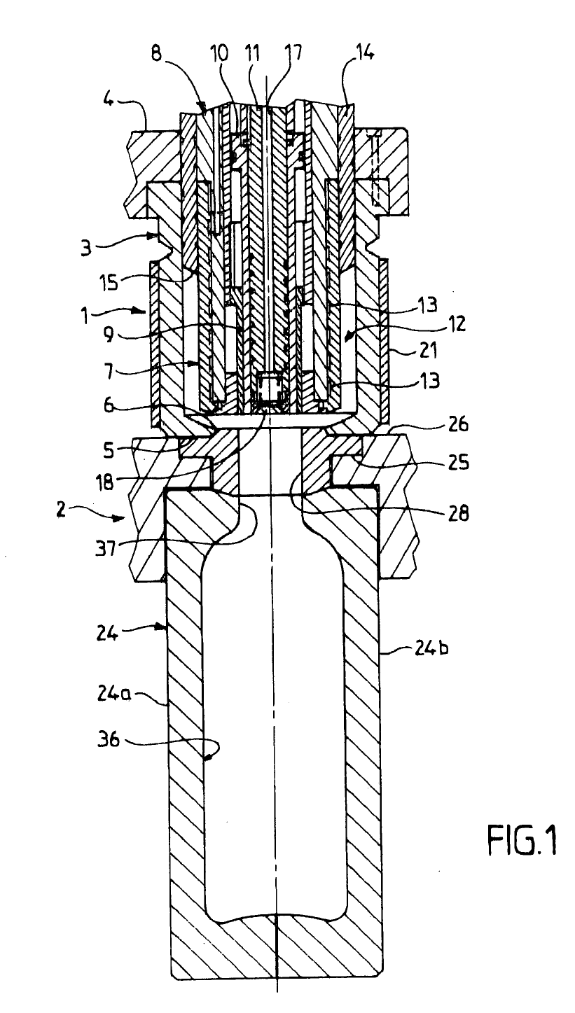

An extrusion-blow-molding machine according to the first embodiment and the way in which it works will now be described. With reference to FIG. 1, the machine comprises an accumulator 1 mounted on a moving support so that it can be associated with two different workstations. In FIG. 1, the accumulator 1 is associated with a molding station 2.

The accumulator 1 comprises a tubular outer envelope 3 which is fixed at its upper end to a support flange 4. The support flange 4 forms part of a rotary plate known per se and not depicted allowing the accumulator 1 to be moved from one workstation to the other. The outer envelope 3 has, at its lower end, a transverse rim 5 which surrounds and delimits an outlet opening 6 of the accumulator 1. Within the outer envelope 3 there is a central core 7 made of several coaxial pieces able to move relative to one another, namely a liner 8, a compacting sleeve 9, a threaded sizing sleeve 10 and a central hollow rod 11. The liner 8 comprises several individual pieces which contain a circuit for circulating heat transfer fluid such as thermal oil. The circuit comprises annular ducts 13 formed near the exterior surface of the liner 8. The sizing sleeve 10 and the central hollow rod 11 constitute a coating mandrel, the function of which will be explained later on.

Between the central core 7 and the internal wall of the outer envelope 3 there is an accumulation space 12 which extends as far as the outlet opening 6 and comprises an annular space closed at its upper end 15 by an extrusion piston 14. In FIG. 1, the extrusion piston 14, the liner 8, the compacting sleeve 9, the sizing sleeve 10 and the central hollow rod 11 are depicted in a position withdrawn up inside the outer envelope 3. These various pieces may be removed axially toward the outside of the outer envelope 3 by a conventional pneumatic drive.

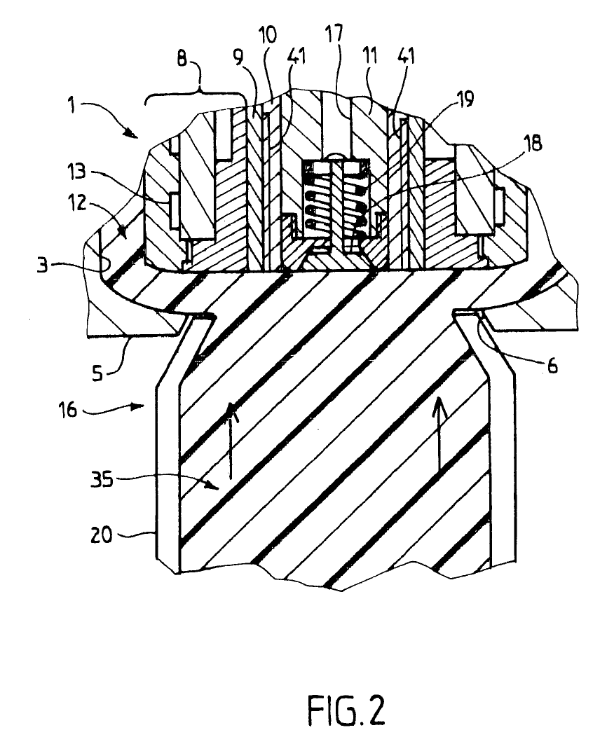

With reference to FIG. 2, the central rod 11 comprises a central duct 17 which is connected at the upper end to a source of pressurized air, not depicted, and which is closed at the lower end by a calibrated valve 18 returned to the closed position by a spring 19. The duct 17 allows bi-orientation to be achieved by blow-molding.

In FIG. 2, the accumulator 1 is depicted associated with the other workstation, which is an injection station 16. The manufacturing cycle for manufacturing a hollow body begins at this station, as will now be explained.

At the injection station 16, an injection-molding machine of the known screw type is used to bring a thermoplastic resin into a malleable state and inject into the accumulation space 12. FIG. 2 depicts only an end part of the injection nozzle 20 which is pressed closely against the outer envelope 3 of the accumulator 1. A predetermined quantity of resin 35 is thus injected into the accumulator 1 in such a way as to fill the accumulation space 12. In order to bring the resin 35 to the optimum temperature for the phase of molding with bi-orientation and to maintain that temperature, the temperature in the accumulation space 12 is regulated by means of a resistive electric element 21 and the circulation of fluid in the circuit of the liner 8.

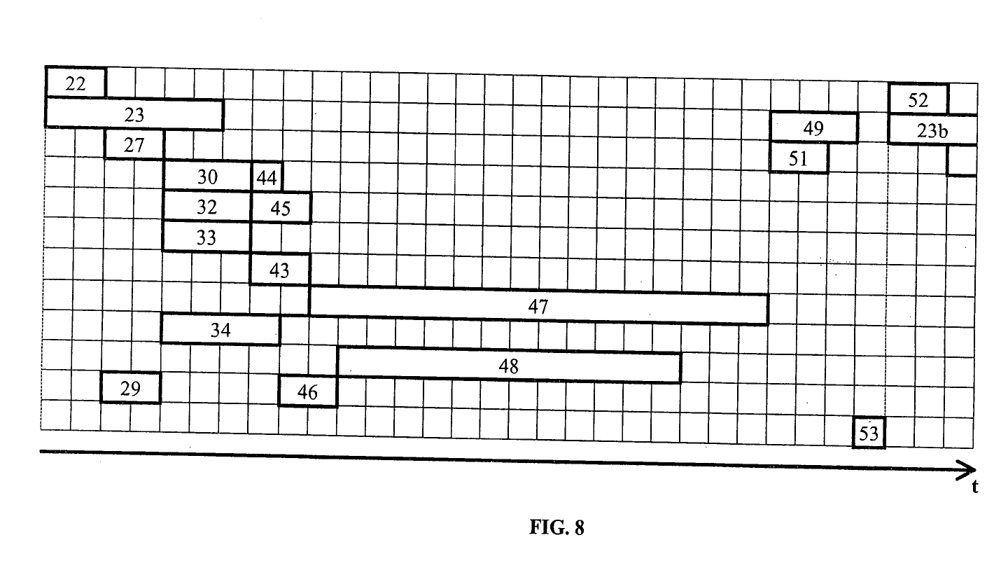

Starting out from this situation, the operation of the machine will be explained with the aid of the diagram of FIG. 8, in which each horizontal box represents a time step lasting about 0.5 s.

In step 22, the accumulator 1 is moved by the support rotary plate to the bi-orientation molding station 2 visible in FIGS. 1 and 3 to 5. A cover, not depicted, covers over the opening 6 during this movement. In FIG. 1, the material contained in the accumulation space 12 is not depicted.

The bi-orientation molding station 2 comprises an extrusion die 25 fixed to a fixed support plate 26, and a blow-molding mold 24 made up of two separate shells 24a and 24b. The shells 24a and 24b are actuated in a transverse movement by a conventional mechanism that allows the mold 24 to be opened and closed. The mold 24 contains an internal cavity 36 which has a restriction portion 37 of a diameter equal to the diameter of the orifice 28 of the extrusion die 25. Step 23, which begins simultaneously with step 22, represents the movement of closing the mold 24. As this movement is known, the mold 24 is depicted in the closed position in all the figures. Step 27 represents the blocking of the rotary support plate at the station 2. The rim 5 is then positioned closely against the upper surface of the extrusion die 25, the accumulator 1 being placed along the axis of the extrusion orifice 28. Step 29 represents the opening of the cover that was covering over the opening 6.

Several operations then begin almost simultaneously: step 30 represents the moving of the extrusion piston 14 to drive the resin out of the accumulation space 12 through the opening 6. Step 32 represents the movement of the pieces of the central core 7. Step 33 represents the pre-blowing of a small air pressure through the duct 17. Step 34 represents the transfer of material through the extrusion orifice 28.

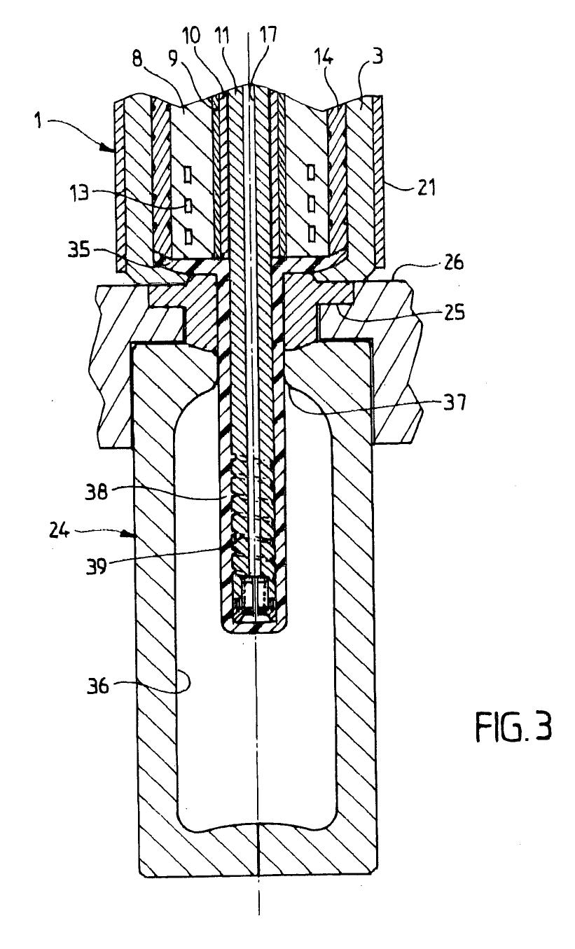

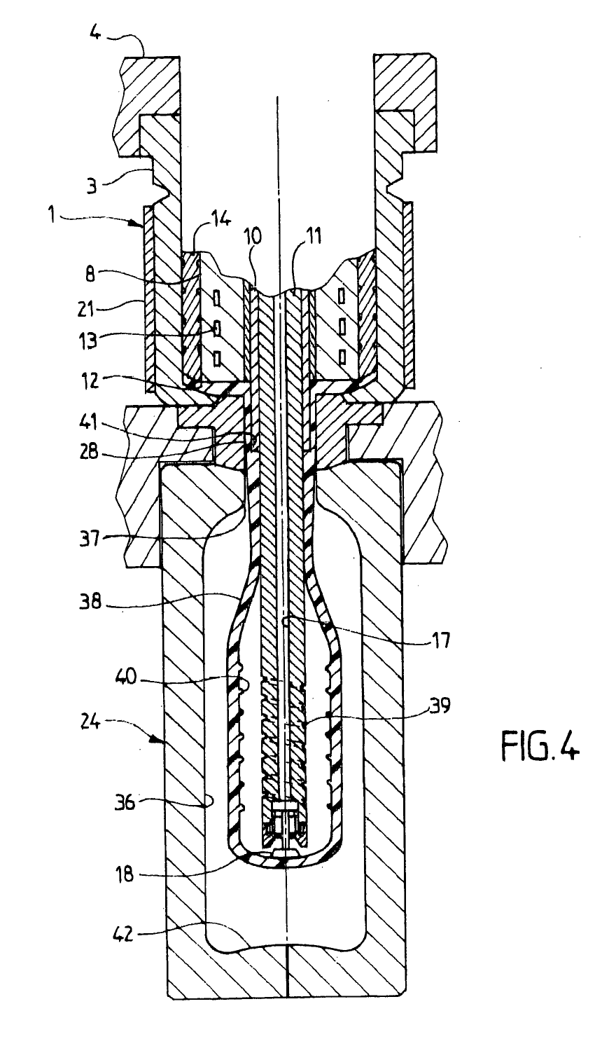

More specifically, in step 32, the central rod 11 is moved first of all and engages through the extrusion die 25 into the mold 24, becoming coated with a uniform coat of resin 38. The forward movement of the central rod 11 is performed at twice the speed at which the resin 35 leaves the extrusion orifice 28, and this causes axial stretching of the coat of resin 38 and corresponding molecular orientation. An end portion of the central rod 11 bears a helical groove 39 on its peripheral surface, and this impresses a corresponding helical rib on the interior surface of the coat of resin 38, as visible in FIG. 3. The slightly delayed pre-blowing of air through the duct 17 of the rod 11 detaches the coat of resin 38 from the rod 11, after the latter has moved axially a certain distance beyond the restriction portion 37, thus avoiding excessively rapid cooling of the resin. The coat of resin 38 detached from the rod 11 is depicted in FIG. 4, in which the helical rib 40 is also depicted. During pre-blowing the coat of resin 38 does not come into contact with the peripheral wall of the cavity 36.

With a delay on the central rod 11, the sizing sleeve 10 is also moved toward the extrusion orifice 28. The sizing sleeve 10 also enters the gap between the rod 11 and the peripheral wall of the extrusion orifice 28. The sizing sleeve 10 has an exterior screw thread 41 best visible in FIG. 2 which impresses a corresponding screw thread on the interior surface of the coat of resin 38. The sizing sleeve 10 moves as far as the restriction portion 37 of the mold 24, so as to form an internal screw thread in the neck of the hollow body that is in the process of being manufactured. For example, the ratio between the internal radius of the extrusion orifice 28 and the gap is about 10.

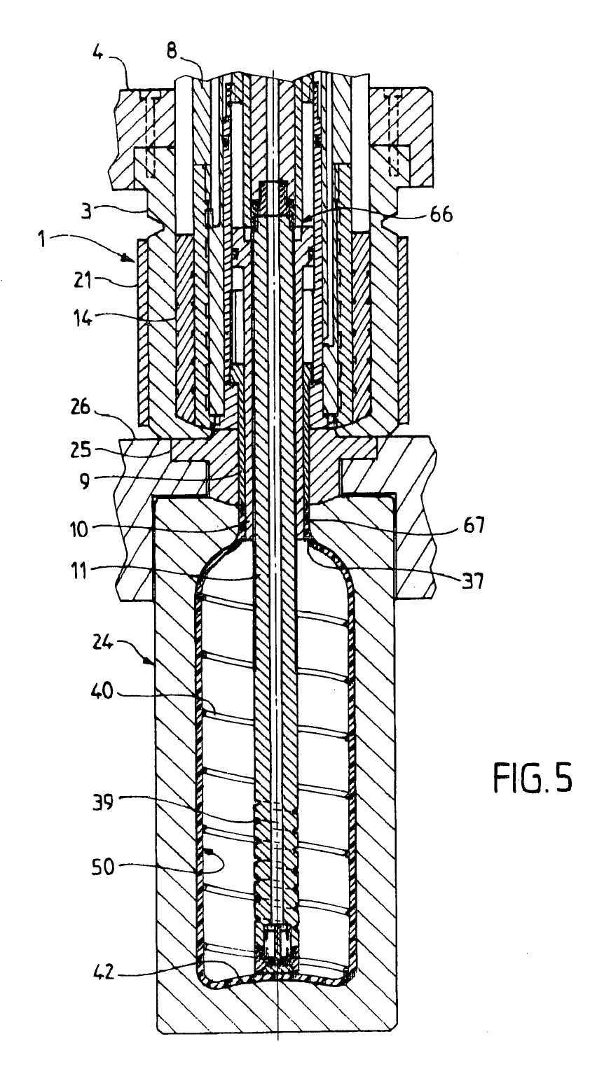

While the rod 11 completes its movement as far as the end wall 42 of the internal cavity 36, the piston 14 and the liner 8 move until they touch the rim 5 in order to completely empty the accumulation space 12. Finally, the compacting sleeve 9 slides as a close fit between the sizing sleeve 10 and the peripheral wall of the extrusion orifice 28 as far as the lower end of the extrusion orifice 28 so as to completely drive the resin from the extrusion die 25 and compress the material in the gap between the sizing sleeve 10 and the restriction portion 37. The end-of-travel position of the various pieces at the end of step 32 is depicted in FIG. 5.

Starting out from this situation, the blow-molding step 43 is performed with a higher air pressure and this transversely dilates the coat of resin 38 until it comes into contact with the walls of the internal cavity 36 and thus completes the molecular bi-orientation of the material and the forming of a hollow body 50. For example, the blowing ratio, that is to say the ratio between the diameter of the extruded parison and the diameter of the hollow body 50 is about ¾. At the same time, step 44 of returning the extrusion piston 14 to the withdrawn position is performed followed by step 45 of returning the pieces of the central punch 7 to the withdrawn position. Thus, the parison is supported until it is finalized. In step 45, the sizing sleeve 9 is rotated so as to unscrew its external screw thread 41 from the corresponding screw thread formed on the interior surface of the coat of resin 38. For that, the central rod 11 is coupled to a numerically-controlled rotary electric motor and the sizing sleeve 9 is coupled to the central rod 11 by a one-way ratchet transmission 66, which allows the sizing sleeve 9 to be driven in the unscrewing direction and also allows the sizing sleeve 9 to rotate more quickly than the central rod 11, thus avoiding forcing the molded screw thread as the sizing sleeve 9 is withdrawn.

Step 46 represents the closing of the cover that covers over the opening 6. Step 47 represents the cooling of the hollow body 50 to the glass transition temperature of the material and beyond. Step 48 represents the phenomenon of corresponding plasticizing of the hollow body 50.

Next, step 49 represents the movement of opening the mold 24 to eject the finished hollow body 50. Step 51 represents the unlocking of the rotary plate and step 52 represents the movement of the rotary plate to return the accumulator 1 to the injection station 16. In a known way, several identical accumulators are preferably provided, these operating simultaneously in hidden time at the various stations. In this case, step 52 is in fact a repeat of step 22 which initiates a new cycle which will be executed in absolutely the same way as the one which has just been described, with another accumulator 1 filled beforehand. Step 53 represents corresponding initialization of the control module of the machine. As can be seen in FIG. 8, the work cycle at the station 2 lasts about 15 s.

The hollow body 50 obtained by the method which has just been described comprises a uniform wall thickness, a helical rib 40 on its interior surface, which enhances its ability to withstand pressure, and an internal screw thread in its neck. Other forms of rib may be obtained in a similar way by adapting the plot of the groove or grooves on the central rod 11. For example, a plurality of parallel peripheral annular grooves makes it possible to obtain a plurality of parallel annular ribs in the hollow body 50, and parallel axial grooves make it possible to obtain axial ribs in the hollow body 50.

In step 32, the ratio between the speed of the central rod 11 and the exit speed of the resin 35 through the extrusion orifice 28 controls the axial elongation ratio of the coat of resin 38 and may be selected according to the desired properties. This ratio is equal to 2 in the example described hereinabove.

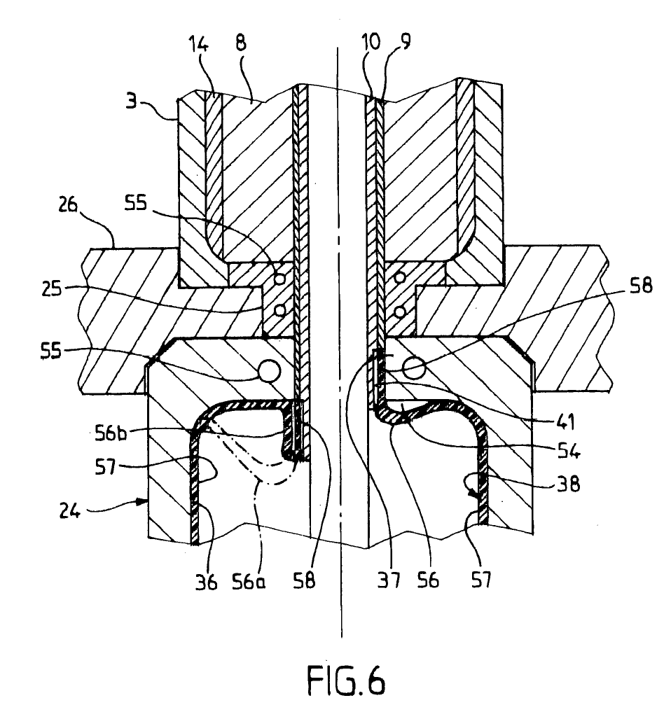

With reference to FIG. 6, a second embodiment of the method of manufacture and a corresponding variant of the molding machine are now described. The same reference numerals are used to denote elements which are identical or similar to those of the first embodiment.

As can be seen in FIG. 6, in the blowing mold 24, the internal cavity 36 has a shoulder face 54 at right angles to the wall of the restriction portion 37. FIG. 6 also depicts annular ducts 55 for the circulation of a heat transfer fluid in the extrusion die 25 and in the restriction portion 37, so as to regulate the temperature of the resin in these regions.

During blow-molding, with pressure being injected through the end of the central rod 11 which is in the closed end of the mold 24, the coat of resin 38 is pressed firmly against the walls of the cavity 36 from the bottom of the mold upward. The right-hand half of FIG. 6 depicts the coat of resin 38 more or less as obtained during the blow-molding step 43 in the first embodiment. In the second embodiment, the sizing sleeve 10 and the compacting sleeve 9 continue to be moved together toward the inside of the mold 24 during blowing. Thus, an area 56 of the coat of resin 38, which is adjacent to an end portion 58 attached to the sizing sleeve 10, is driven away from the shoulder face 54 and thus folds over toward a lower portion 57 of the coat of resin 38, which is attached to the peripheral wall of the cavity 36. The area 56 remains more supple than the remainder of the coat of resin 38 because the absence of contact with the mold 24 and the coating mandrel slows its cooling.

The left-hand part of FIG. 6 depicts, at numeral 56a, the area as it is approximately positioned when the sleeves 9 and 10 reach the end of their travel. In this embodiment, the compacting sleeve 9 also sweeps the restriction portion 37 of the blow-molding mold 24 and the threaded part of the sizing sleeve 10 enters the main cavity of the mold 24. Finally, blowing is completed with a higher pressure, and this folds the folded area against the end portion 58, as shown at the numeral 56b, forming an elbow of material. This then yields a neck with a double wall and an internal screw thread. The remainder of the method is identical to the first embodiment.

Large capacity hollow bodies, for example with a capacity of 200 liters, may be manufactured. In particular, it is possible to manufacture hollow bodies able to withstand high internal pressures, because of the quality of their walls and the presence of reinforcing ribs on their interior surface. The wall thickness is regulated by the size of the gap around the central rod 11 in the extrusion orifice 28.

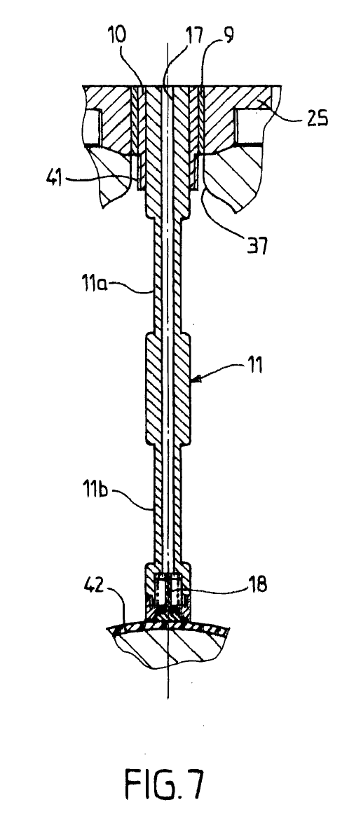

FIG. 7 depicts a variant embodiment of the central rod 11, in which this rod has two portions 11a and 11b having a smaller diameter by comparison with the remainder of the rod 11, so as to form, by coating, a parison which has a stepped thickness and so as thus to obtain a hollow body which has a peripheral wall which is stepped in terms of its thickness and/or in terms of its diameter. The thinner portions 11a and 11b thus make it possible to obtain a greater thickness of the walls at the bottom and at the top of the hollow body 50, which are the regions where the greatest pressure is exerted when the hollow body is used as a pressurized reservoir.

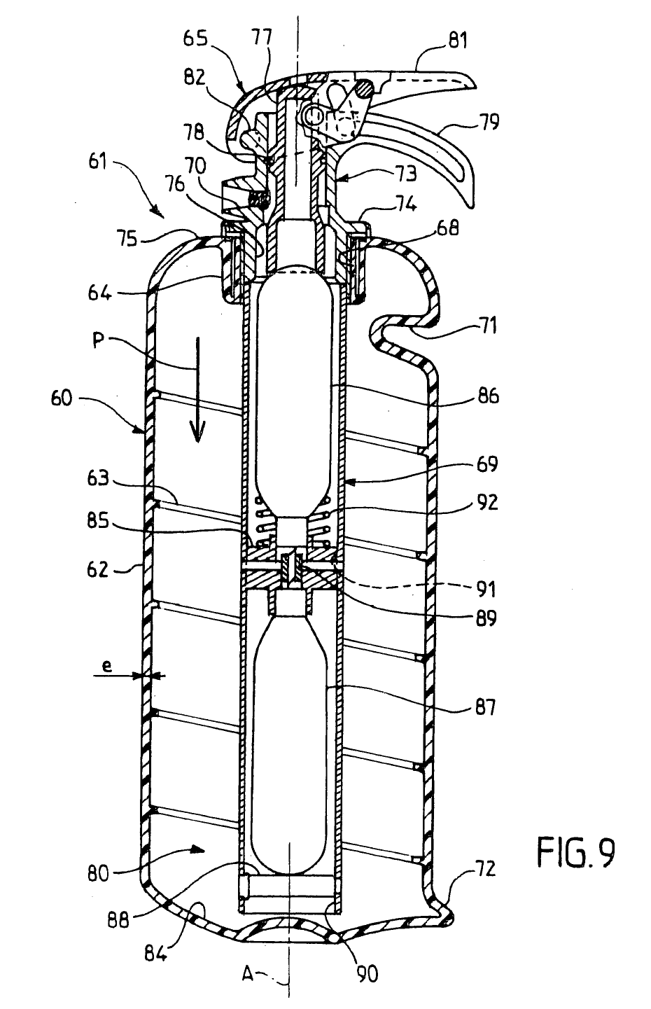

FIG. 9 depicts a hollow body obtained using a device according to the second embodiment described and used as a reservoir 60 of a portable extinguisher 61. The reservoir 60 is manufactured, for example, in a polymer resin crosslinked by ion bonds known by the trade name Surlyn® and manufactured by DuPont®. This material has excellent transparency, good resistance to scratching, a broad range of operating temperatures and very good resistance to organic solvents. The wall 62 has a more or less uniform thickness e of between 3 and 5 mm, to contain a pressure of 55 bar. Its interior surface bears a helical rib 63, having, for example, a height of about 1 mm. The neck 64 of the reservoir 60 has a double wall and an internal screw thread 68 for screwing on a discharge device 65.

The discharge device 65 comprises a hollow sleeve 73 of which the lower portion has a screw thread designed to screw into the interior screw thread 68 of the neck 64. A peripheral rim 74 bears against the upper surface 75 of the reservoir 60 in the assembled state. The sleeve 73 comprises an interior bore 76 in which a plunger 77 equipped with a seal 78 slides in a sealed manner. A fixed handgrip 79 is fixed to the top of the sleeve 73. A discharge control lever 81 is also fixed to the top of the sleeve 73 such as to pivot about an axis 82. A lower surface of the lever 81 bears against the top of the plunger 77.

A dip tube 69 is pushed into the sleeve 73 and extends from the lower end thereof down to a bottom part 80 of the reservoir 60, near the bottom wall 84. A transverse support 85 is arranged mid-way along the tube 69 in its internal section. A first cartridge of pressurized gas 86, for example carbon dioxide, is placed in the tube 69 resting between the plunger 77 and the support 85 by means of a compression spring 92. A second cartridge of pressurized gas 87 is placed in the tube 69 resting between the support 85 and a rib 88. A puncturing insert 89 is arranged in the support 85 with two cutting ends directed along the axis A of the tube 69 toward respective blanking disks of the cartridges 87 and 86.

The extinguisher 61 is a portable hand-held disposable extinguisher, the operation of which is explained hereinbelow. FIG. 9 depicts the state of the extinguisher ready for use. The extinguishing agent contained in the reservoir 60 is not depicted. In order to force the extinguishing agent to be discharged, the lever 81 is manually lowered toward the handle 79, and this pushes the plunger 77 against the bottom of the cartridge 86. The cartridge 86 comes into contact with the insert 89 which pierces its blanking disk and thus releases the pressurized gas. The movement of the cartridge 86 continues, pushing the insert 89 against the blanking disk of the cartridge 87 in order also to puncture that. The pressurized gas, for example, at 55 bar, becomes concentrated in the top of the reservoir 60 as a result of the difference in density and exerts on the extinguishing agent, for example, a powder, a thrust force directed overall toward the bottom part 80 of the reservoir, as depicted by the arrow P. The extinguishing agent is driven toward the end opening 90 of the dip tube and at the same time is driven in a swirling movement around the tube 69 because of the orientation of the rib 63, the axis of winding of which coincides with the axis A of the tube 69. The extinguishing agent rises up inside the tube 69, crosses the support 85 via passages 91 situated outside the plane of FIG. 9, and rises up inside the interior bore 76 of the sleeve 73 as far as the outlet nozzle 70, through which it is discharged in the form of a divergent jet. Discharge lasts until the store of pressurized gas has been exhausted. At this final stage, the residual amount of extinguishing agent in the reservoir 60 is very small.

The shape of the reservoir 60 may be chosen at will by adapting the shape of the blow-molding mold. For example, the cross section of the reservoir 60 may be circular or polygonal. In the same way, ergonomic shapes are produced in the wall of the reservoir 60, such as a hollow handgrip 71 and a projecting tab 72, so as to obtain a complete finish of the reservoir of the extinguisher according to its use.

The extinguisher 61 may also be of the type with permanent pressure without there being any need to modify the reservoir 60. The plastic of the reservoir 60 may also be colored, particularly in accordance with fire-safety standards.

Although the invention has been described in conjunction with one particular embodiment, it is obvious that it is not in any way restricted thereto and that it comprises all the technical equivalents of the means described and combinations thereof if the latter fall within the scope of the invention.

1. A fire extinguisher (61) comprising a reservoir made of plastic (60) able to contain a pressurized extinguishing agent, and a discharge device (65) fixed to a neck (64) of said reservoir so as to discharge said extinguishing agent, said discharge device comprising an outlet nozzle (70), and a dip tube (69) arranged in said reservoir (60) in such a way as to be able to lead said extinguishing agent from a bottom part (80) of said reservoir at the opposite end to said neck toward said outlet nozzle, characterized in that a wall (62) of said reservoir bears an internal rib (63) of helical shape, the axis (a) of winding of which is more or less parallel to said dip tube (69).

2. The fire extinguisher as claimed in claim 1, characterized in that said neck (64) is formed of a double wall projecting toward the inside of said reservoir.

3. The fire extinguisher as claimed in claim 1, characterized in that said neck (64) comprises an internal screw thread (68) for fixing said discharge device (65) by screwing.

4. The fire extinguisher as claimed in claim 1, characterized in that it comprises at least one external accessory (72) molded as a projection on an exterior surface of said wall (62) of the reservoir.

5. The fire extinguisher as claimed in claim 1, characterized in that it comprises at least one external handgrip (71) molded as a recess in said wall (62) of the reservoir.

6. The fire extinguisher as claimed in claim 1, characterized in that said wall (62) of the reservoir has a thickness (e) of between 3 and 5 mm.

7. The fire extinguisher as claimed in claim 1, characterized in that it has an internal working pressure in excess of 50 bar.

8. The fire extinguisher as claimed in claim 1, characterized in that said reservoir (60) has a polygonal cross section.

9. The fire extinguisher as claimed in claim 1, characterized in that said extinguishing agent is a powder or water with one or more additives.

10. The fire extinguisher as claimed in claim 1, characterized in that said reservoir (60) can be obtained by a molding process with bi-orientation, comprising steps of coating (32) a moving mandrel (10, 11) bearing a helical groove (39) and of blow-molding (43).

11. The fire extinguisher as claimed in claim 2, characterized in that said neck (64) comprises an internal screw thread (68) for fixing said discharge device (65) by screwing.
